(19) United States
(12) Patent Application Publication
(10) Pub. No.: US 2009/0249897 A1
(43) Pub. Date: Oct. 8, 2009

(54) TRANSFER OF SUBSTANCES ADHERING TO SURFACES INTO A DETECTION INSTRUMENT

(75) Inventors: Hans-Rudiger Doring, Leipzig (DE); Stefan Ettrich, Leipzig (DE)

Correspondence Address: Paul E. Kudirka;Law Offices of Paul E. Kudirka, Suite 300, 40 Broad, Boston, MA, 02109, US

(73) Assignee: Bruker Daltonik GmbH, Bremen (DE)

(21) Appl. No.: 12/404,779

(22) Filed: Mar. 16, 2009

(30) Foreign Application Priority Data
Mar. 19, 2008 (DE) 10 2008 0150001.0

(51) Int. Cl. G01N 1/04; H01J 49/26

(52) U.S. Cl. 73/864.71; 250/282

(57) ABSTRACT

A method for the transfer of target substances (drugs, pollutants, explosives and chemical warfare agents) from a surface to be investigated into a detection instrument, the target substances being present in the form of condensations of vapors on the surface itself or on particles adhering to it, or as particles sticking to the surface. The method comprises the steps of (a) moving a sampler, consisting of either a fiber bundle or a fastener strip with fiber loops, over the surface to be investigated, thus transferring substances to the fibers or the fiber loops or embedding particles into the gaps between the fibers or the fiber loops of the sampler, (b) transferring the sampler into a desorption device of the detection device, and (c) heating the sampler to evaporate the target substances. Various sampler designs can be incorporated into devices using the method.

### BACKGROUND

The present invention relates to methods and devices for the transfer of target substances (drugs, pollutants, explosives and chemical warfare agents) from a surface to be investigated into a detection instrument, the target substances being present in the form of condensations of vapors on the surface itself or on particles adhering to it, or as particles sticking to the surface.

The increasing terrorist threat has increased the importance of the detection of explosives and chemical warfare agents, not only in the military sector but also for civil defense. On the one hand, the task is to prevent their illegal import and attacks on transport systems such as planes or ships. On the other hand, civil defense is increasingly being extended to public buildings and domestic transport systems. In addition to the threat from explosives and chemical warfare agents, there is also the problem of drug smuggling across national borders. This particularly results in a greatly increasing demand for detection devices at airports, seaports and border control stations where the illegal or hazardous target substances are transported both in baggage and in industrial containers.

The target substances are usually detected via their vapors, but there are methods of packaging the substances into vapor tight containers. Nevertheless, during the packaging process, vapor condenses invisibly on the surfaces of the containers, or extremely fine dust of the substances sets down on the surfaces. However, transferring the target substances from an object to be investigated into a suitable detection device presents a task that should not be underestimated. The detection instruments used today include mass spectrometers (MS), ion mobility spectrometers (IMS), and gas or liquid chromatographs.

Ion mobility spectrometry, in particular, represents a highly sensitive and robust method that is able to detect substances at low concentrations. The ion mobility spectrometers used for the above-stated applications are usually operated at atmospheric pressure, and their simple, compact design means that they can be used in large numbers and as mobile detection devices. In an ion mobility spectrometer, the substances to be detected are first ionized. The ions then move in a drift gas under the influence of electric fields. The ions of different substances are separated on the basis of their mobility or the field-strength dependence of their mobility, and are detected in an ion detector. The drift gas is typically circulated in a closed gas loop; an inlet membrane is flushed from the outside with a sample gas containing the substances, some of which are introduced into the gas loop via the inlet membrane.

The detection of modern explosives and drugs, in particular, is hampered by the fact that these target substances have a very low vapor pressure and are enclosed in transport containers. In most cases, direct detection of these target substances in the ambient air is therefore only possible by collecting a large sample volume with subsequent enrichment.

However, the surfaces of the baggage, the transport containers and the clothes and skin of the persons doing the packing are usually contaminated with minimal traces of the substances, which are present as condensations from vapors on the surface itself or as particles adhering to the surface of the containers. They have too low vapor pressures to be directly detectable in the ambient air. The surfaces to be investigated are therefore wiped with a sampler, causing condensed substances and particles carrying the substances to be removed from the surface and to adhere to the sampler. The sampler with the wiped up substances and embedded particles is transferred into a desorption device of a detection instrument, where it is heated in order to achieve vapor pressures of the substances which are sufficient for detection.

Paper, woven fabrics or felt, for example, are currently used as samplers, based on the swabbing of surfaces to be investigated. The patent publication US 2005/0288616 A1 (Bozenbury et al.) utilizes a cellulosic fabric sponge made from cotton, linen or rayon with a pore size of a few tens of micrometers. Samplers made from cotton which are slipped over two fingers or are shaped like a glove are described in the patents U.S. Pat. No. 5,571,976 A (Drolet) and U.S. Pat. No. 5,476,794 (O'Brien). In the patent publication WO 1997/038294 A1 (Danylewych-May et al.), the sampler consists of a piece of fabric stretched over a hemisphere by means of a ring. The ring and the hemisphere consist of a chemically and thermally resistant material. The surfaces to be investigated are wiped with the fabric stretched over the hemisphere without the cloth's coming into contact with the person taking the sample. The patent U.S. Pat. No. 6,642,513 B1 (Jenkins et al.) presents samplers which are made of a Teflon-coated glass fiber fabric or a non-woven polyamide felt, some of the glass fibers in the glass fiber material being broken open and protruding from the surface.

All of the above-mentioned samplers for wiping up samples have the following problems. The sampler is relatively large (>4×4 cm), which requires a correspondingly large desorption device with a high energy demand, thus often greatly limiting their mobile use. Furthermore, the materials used in samplers made from paper and woven fabrics are usually not chemically stable at desorption temperatures above 200 degrees Celsius. These samplers then themselves emit substances which can give rise to false results (false negative and false positive) by reactions with target substances and superimpositions of signals.

In the publications by Mina et al. (IJIMS 4 (2001) 1, 37-40: “Evaluation of Sample Collectors for Ion Mobility Spectrometry”) and Jadamec et al. (3rd International Workshop on IMS, 1994, Galveston (USA): “The Effect of Sample Holder Material on Ion Mobility Spectrometry Reproducibility”), the necessary and desired properties of a sampler for wiping up samples are summarized:
The sampler must be flexible in order to adapt to the contours and roughness of the surfaces to be investigated.
The sampler must be mechanically strong so that it does not rip during swabbing or lose bits (e.g., fibers).
The sampler must have sufficient surface roughness to be able to take up the substances and particles adhering to the surfaces.
The sampler must be chemically stable at desorption temperatures above 200 degrees Celsius.

These properties are not fulfilled in their entirety by the usual samplers for wiping up samples currently in use and the materials used for them (woven fabrics, felts, paper, porous Teflon film).

Prior art methods are also known for the sampling of particles adhering to surfaces whereby brushes are used to remove the particles to be investigated from the surface. The particles removed are either brushed together with the brushes (“dust pan-brush arrangements” in WO 1997/038294 A1) or are conveyed in an air stream to a filter where they are collected (“rotating brushes” in U.S. Pat. No. 5,345,809 A and “mechanical brushing” in U.S. Pat. No. 6,946,300 B2).

### SUMMARY

The invention provides methods and devices for the transfer of target substances adhering to surfaces into a detection device, the target substances being, in particular, drugs, pollutants, explosives or chemical warfare agents which are present as condensations from vapors on the surface itself or on particles adhering to it, or as fine dust particles of the target substances.

The invention provides a method to move a sampler, either a bundle of fibers or strip of loop fasteners, across a surface to be investigated. with contact between the fibers or loops and the surface, so that substances are transferred from the surface to the fibers or particles are embedded in the gaps between the fibers or loops; subsequently the fiber bundle or loop strip is transferred into a desorption device of a detection device and heated up to evaporate the target substances. The target substances (drugs, pollutants, explosives or chemical warfare agents) are preferably detected by ion mobility spectrometers, which are very robust and have a very low detection limit, depending on the respective target substance.

### BRIEF DESCRIPTION OF THE DRAWINGS

FIGS. 1A and 1B show a method for the transfer of target substances (1) from a surface to be investigated (3) into a desorption device (4) of an ion mobility spectrometer (7), which is only depicted schematically; the substances (1) are present on the surface to be analyzed (3) itself or on or as particles (2) adhering to it. In the first step of the method shown in FIG. 1A, a sampler (10), which comprises a conical tube support (11), a pickup consisting of a fiber bundle (12) made from parallel flexible glass fibers and a handle (13), is moved over the surface to be analyzed (3). Some of the substances (1) and particles (2) are thus transferred onto the fiber bundle (12) or embedded into the gaps between the fiber bundles (12). In the second step of the method shown in FIG. 1B, the sampler (10) is transferred into the desorption device (4), where it is heated.

FIG. 2 shows a second sampler (20) according to the invention which comprises a support (21), a pickup consisting of a fiber bundle (22) of parallel flexible glass fibers and a handle (23), the fiber bundle (22) being mechanically fixed at both ends (22a, 22b) on the support (21).

FIG. 3 depicts a third sampler according to the invention (30) which comprises a support (31), a pickup consisting of a fastener strip with fiber loops (32) and a handle (33). The polyimide fiber loops (32) are irregularly arranged on the support (31).

### DETAILED DESCRIPTION

While the invention has been shown and described with reference to a number of embodiments thereof, it will be recognized by those skilled in the art that various changes in form and detail may be made herein without departing from the spirit and scope of the invention as defined by the appended claims.

A first sample transfer device according to the invention (simply called sampler in the following) consists of a multitude of parallel flexible fibers, the fiber density being greater than 50 fibers per square millimeter and the fiber length being more than half a millimeter. The fibers can be mechanically fixed at one end of the fiber bundle, at both ends of the fiber bundle, or between the two ends of the fiber bundle. In the first case, the fiber bundle resembles a paintbrush or cleaning brush. The free end of such a fiber bundle adapts well to the contours of the surface to be investigated. The surface of a fiber bundle's free end can be flat or convex, and a flat end surface can be perpendicular or at an angle to the axis of the fiber bundle. The fibers of the fiber bundle preferably have a thickness of between 5 and 100 micrometers and a free length of between a half and 20 millimeters.

The probability of individual fibers breaking off is very low if between 10³ and 10⁵ fibers, in particular about 10⁴ fibers, are combined into a fiber bundle and the length of the fibers corresponds to between one and five times the diameter of the fiber bundle, in particular three times the diameter. The fibers support each other without limiting the flexibility necessary for the sampling. If the fibers are very long, there is a danger that the fibers will break off on contact with the surface to be investigated. In order to reduce the likelihood of the fibers breaking, the fiber bundle can be mechanically fixed at both ends, as has already been described above. The free length of the fibers in the fiber bundle is preferably about five millimeters in all cases.

A second device according to the invention for the sample transfer consists of a strip of loop fasteners. As is the case with one of the two parts of the familiar hook-and-loop textile fasteners, the strip consists of flexible fiber loops. Every fiber loop is mechanically fixed at both ends. In contrast to the fiber bundles fixed at two ends, the fiber loops are not aligned parallel to each other. An irregular arrangement of the fiber loops on the strip is preferable, but regular arrangements are also possible. The area density of the fiber loops on the strip is preferably higher than 50 fiber loops per square millimeter. The fiber loops are preferably longer than half a millimeter and usually have different lengths.

The temperature that is necessary to desorb the target substances from the fibers, the fiber loops and the particles embedded there is typically between 100 and 400 degrees Celsius, in particular between 150 and 200 degrees Celsius. It is also possible to use a temperature profile which increases with time so that substances with different desorption temperatures are desorbed at different times. This additional information increases the number of target substances that can be detected, particularly for ion mobility spectrometers.

The materials used in the samplers must be chemically stable when heated to the respective desorption temperature and should themselves emit no, or only very small quantities of, additional substances in order not to interfere with the detection of the target substances. The fibers and fiber loops are preferably glass, but plastic (e.g., polyimide), metals or carbon are also suitable materials. Fiber mixtures of different materials are also possible.

The sampler can be heated in a variety of ways, for example by:
thermal contact between the fiber bundle or the strip of loop fasteners and a heating element,
the flow of a hot gas stream through the fiber bundle or the strip of loop fasteners, the direction of flow being perpendicular to or along the bundle or the strip of loop fasteners,
heat radiation,
capacitive heating of non-metallic fibers/fiber loops,
inductive heating of metallic fibers/fiber loops, or
an electric current through the fibers/fiber loops if the two fixed ends of the fibers or fiber loops are electrically insulated from each other and have a suitable electrical conductivity.

It is also preferable for the fibers and fiber loops to be rough at the surface (microstructured) or chemically or mechanically coated or both. The roughness enables the mechanical removal of substances that are present as a layer on the surface to be investigated, and also ensures that the particles thus produced, or already present, are held between the fibers or the fiber loops. Like a “glue”, the coating can increase an unspecific adhesion of substances and particles to the fibers and fiber loops. But coatings are also known with which certain target substances are chemically altered so that they can be desorbed more easily. With other coatings, only interferents are bound to the fibers and fiber loops or made to react so that, at the desorption temperatures, the interferents do not, or scarcely, go into the vapor phase. This kind of specific coating reduces the number of positive false alarms.

In the samplers for wiping up samples known from the prior art, meshes or pores are responsible for transferring substances or particles from the surfaces to be investigated onto the sampler. In the devices according to the invention, the gaps between the fibers or the fiber loops assume the role of the meshes and pores. The gaps have different widths, depending on the bending of the fibers or fiber loops, enabling good adaptation to how the target substances are present on the surface. The target substances can be present as a solid coating, which is scratched off the surface during sampling, for example, or be present on particles of different sizes, which are embedded between the fibers or fiber loops in variable gaps.

The gaps of the fiber bundles and strips of loop fasteners according to the invention have a large inner surface, while the samplers for wiping up samples known from the prior art are rather flat tools with small inner surface. With paper and films, the depth of the pores is limited by the thickness of the material, usually to less than 0.1 millimeters. With fabrics, the thickness of the material is about five to ten times greater. Only with a bundle of fibers or a strip of loop fasteners with a suitably large number of long fibers and fiber loops is the surface area of the gaps considerably larger than the surface of the sampler, and therefore larger quantities of the target substances can be taken up from the surface to be investigated and transferred to the detection device.

As is known from the prior art, brush-like devices have already been used for sampling particles (“dust”) from surfaces for the detection of target substances such as drugs, pollutants, explosives and chemical warfare agents. However, the brushes are only used to mechanically remove particles from the surfaces to be investigated. Collection of the particles and their transfer to a detection device by means of brushes cannot be found in the prior art, nor can heating of the brushes used in a desorption device. Instead, the particles are wiped off (“dust-pan/brush arrangements”) or guided by an air stream to a collecting filter. Thus, in both cases, particles must even be prevented from adhering to the brushes. In contrast to the prior art, the samplers according to the invention are designed so that they take up the particles effectively and are chemically stable at the required desorption temperatures. In particular, the high fiber density and the length of the fibers in the fiber bundles guarantee that they are very effective at removing and taking up particles adhering to surfaces.

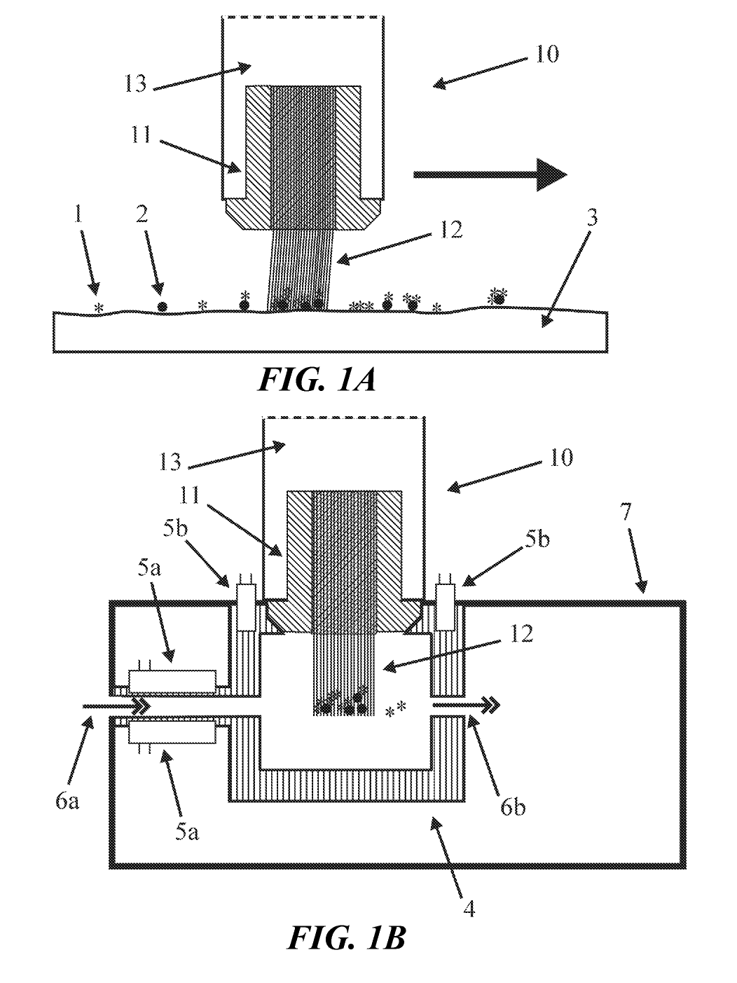

FIG. 1A shows a first sampler (10) according to the invention which comprises a conical tube support (11), a pickup consisting of a fiber bundle (12) of flexible parallel glass fibers and a handle (13).

The fiber bundle (12) contains about 10⁴ glass fibers 30 micrometers in diameter and 15 millimeters in length. One end of the fiber bundle (12) is mechanically fixed in the tube (11), which is approx. 10 millimeters shorter than the fibers, so that the glass fibers protrude about 5 millimeters from the tube (11) at the free end and finish flush. The tube (11) is circular on the inside and has an internal diameter of about 3 millimeters.

In order to fix the fiber bundle (12) in the tube (11), the gaps between the glass fibers, and between the glass fibers and the inside surface of the tube (11), are filled with a material which (a) is chemically stable and solid at a temperature of up to 400 degrees Celsius, (b) resistant to the target substances and (c) adheres well to the glass fibers and the inside surface of the tube (11). A material with said properties is, for example, ceramic adhesive. Another type of mechanical fixation consists in crimping the tube (11) at one or more points from the outside.

As shown in FIG. 1B, the desorption device (4) has two heating elements (5a, 5b). The gas stream that is introduced at the inlet (6a) is heated by the heating element (5a). The second heating element (5b) is positioned near an aperture of the desorption device (4) into which the sampler (10) is introduced for the desorption process. The tube (11) is composed of metal and the end where the fiber bundle (12) protrudes is conical so that the sampler (10) can seal the desorption device (4) with respect to the surroundings and heat is transferred between the heated wall of the desorption device (4) and the sampler (10). The handle (13) surrounds the tube (11) and is composed of a material with low thermal conductivity so that it can be handled manually, particularly during and after the desorption process. The gas stream introduced at the inlet (6a) enters an ion mobility spectrometer (7), which is only schematically depicted, via the outlet (6b).

In the first step of the method shown in FIG. 1A, the sampler (10) is moved across the surface to be investigated (3), with contact between the pickup and the surface. The axis of the free end of the fiber bundle (12) can be perpendicular to the surface (3) or it can be inclined at an angle of up to 600 to the surface (3) by applying light pressure. The multitude of thin fibers and their flexibility make it possible for the fiber bundle (12) to adapt well to the contours and roughness of the surface to be investigated (3) and to take up substances (1) and particles (2) from the surface (3). In the second step of the method shown in FIG. 1B, the sampler (10), which is loaded with substances (1) and particles (2), is introduced into the aperture of the desorption device (4) provided for this purpose. The fiber bundle (12) is heated to between 150 and 200 degrees Celsius by heat conduction via the tube (11), by heat radiation from the inner surface of the desorption device (4) and by the heated gas stream. The substances adsorbed on the glass fibers themselves or on the particles (2) embedded in the fiber bundle are desorbed by the heating and removed from the desorption device (4) by the gas stream via the outlet (6b). The target substances are detected in the schematically depicted ion mobility spectrometer (7) in the familiar way.

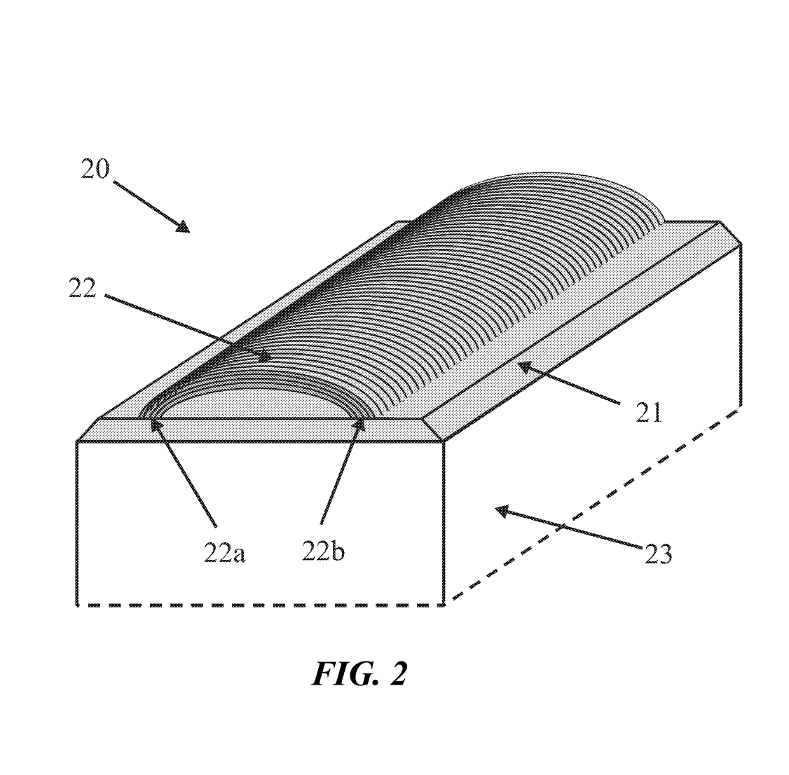

FIG. 2 shows a second sampler according to the invention (20), comprising a support (21), a pickup consisting of a fiber bundle (22) of parallel flexible glass fibers and a handle (23). In contrast to the sampler (10), the fiber bundle (22) here is mechanically fixed at both ends (22a, 22b) onto the support (21). The fiber bundle (22) extends over a rectangular area of about 200 square millimeters. The average length of the glass fibers between the two fixed ends (22a, 22b) is about ten millimeters. The thickness of the fiber bundle (22) is about 2 millimeters. The probability of the 20 micrometer thick glass fibers breaking is considerably reduced by the mechanical fixation at both ends. The support (21) is conically chamfered. The handle (23) consists of a material with low thermal conductivity. Samplers according to the invention are also possible which have several fiber bundles of parallel flexible fibers arranged side by side and thus have a larger “swabbing area”.

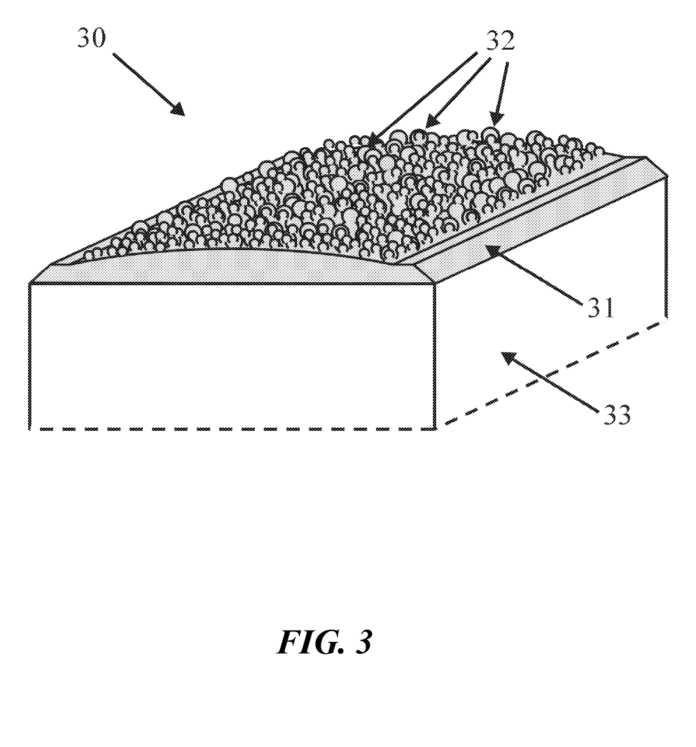

FIG. 3 depicts a third sampler according to the invention (30) which comprises a support (31), a pickup consisting of a multitude of fiber loops (32) and a handle (33). The fiber loops (32) are made from polyimide and are arranged irregularly on the support (31). All together they form a strip of loop fasteners. The fiber loops (32) here are between a half and four millimeters long and about 30 micrometers thick. The area density is about 300 fiber loops per square millimeter. As in the previous example embodiment, the support (31) is also chamfered at the sides and the handle (33) has a low thermal conductivity so that it does not excessively heat up during the desorption process. The support area (31) measures around 100 square millimeters and is slightly convex.

With knowledge of the invention, those skilled in the art can design other example embodiments according to the invention for samplers. The detection instrument, in particular, is not limited to ion mobility spectrometers.

What is claimed is:

1. A method for the transfer of target substances from a surface into a detection device, the substances being present as condensations of vapors on the surface itself or on particles adhering thereto or as substance dust, comprising the steps:
(a) moving a sampler having a pickup consisting of one of a fiber bundle and a fastener strip of fiber loops across the surface, with contact between the pickup and the surface;
(b) transferring the sampler into a desorption device of a detection device; and
(c) heating the sampler to evaporate the target substances.

2. The method of claim 1, wherein step (c) comprises heating the pickup to a temperature of more than 100° C.

3. The method of claim 1, wherein step (c) comprises heating the pickup by a stream of hot gas.

4. The method of claim 3, wherein the gas stream has a temperature of more than 100° C.

5. The method of claim 1 wherein step (b) comprises transferring the sampler into a desorption device of an ion mobility spectrometer.

6. A device for transferring samples of condensed substances and particles adhering to surfaces into a detection device, comprising:
a plurality of flexible fibers, each fiber having a length of more than half a millimeter, and
a support which holds the fibers parallel to each other with a fiber density higher than 50 fibers per square millimeter.

7. The device of claim 6, wherein the support mechanically fixes the fibers at one end.

8. The device of claim 6, wherein the support mechanically fixes the fibers at both ends.

9. The device of claim 6, wherein each fiber is cylindrical and has a diameter greater than 5 micrometers.

10. The device of claim 6, wherein the plurality of fibers comprises between 10³ and 10⁵ fibers.

11. The device of claim 6, wherein the support holds the plurality of fibers in a fiber bundle with a diameter and each fiber extends from the support for a distance of between one and five times the diameter of the fiber bundle.

12. The device of claim 6, wherein each fiber is fabricated from a material selected from a group consisting of glass fibers, plastic fibers, metal fibers and carbon fibers.

13. A device for transferring samples of substances and particles adhering to surfaces into a detection device, comprising:
a surface having edges and a plurality of flexible fiber loops extending therefrom; and
a support for holding the surface at the edges.

14. The device of claim 13, wherein the density of the plurality of loops on the surface is higher than 50 fiber loops per square millimeter of the surface.

15. The device of claim 13, wherein the fiber loops extend to different heights from the surface.

16. The device of claim 13, wherein each of the fiber loops is longer than half a millimeter.

17. The device of claim 13, wherein each of the fiber loops is fabricated from a material selected from a group consisting of glass fibers, plastic fibers, metal fibers and carbon fibers.
